(19) United States
(12) Patent Application Publication
(10) Pub. No.: US 2010/0138273 A1
(43) Pub. Date: Jun. 3, 2010

(54) REPEATABILITY INDEX TO ENHANCE SEASONAL PRODUCT FORECASTING

(76) Inventors: Arash Bateni, Toronto (CA); Edward Kim, Toronto (CA); David Chan, Toronto (CA)

Correspondence Address: JAMES M. STOVER;TERADATA CORPORATION, 2835 MIAMI VILLAGE DRIVE, MIAMISBURG, OH, 45342, US

(21) Appl. No.: 12/325,414

(22) Filed: Dec. 1, 2008

(51) Int. Cl. G06Q 10/00

(52) U.S. Cl. 705/10

(57) ABSTRACT

A repeatability score is described for determining the quality and reliability of product sales data for generating seasonal demand forecasts. The repeatability scores are calculated from seasonal sales data stored in a data warehouse. Products are sorted based on their reliability scores such that those products that are highly seasonal and have a reliable year-to-year demand pattern are used to form initial or unique demand models. Products that are determined to be less reliable based on their repeatability score are added to the unique demand models through an iterative matching process or left out of the unique demand models.

### FIELD OF THE INVENTION

The present invention relates to methods and systems for forecasting product demand for retail operations, and in particular to the determination of seasonal selling patterns.

### BACKGROUND OF THE INVENTION

Accurately determining demand forecasts for products is a paramount concern for retail organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, inventory that exceeds a current demand can adversely impact the profits of an organization. Excessive inventory of perishable goods may lead to a loss for those goods, and heavy discounting of end of season products can cut into gross margins.

### SUMMARY OF THE DISCLOSURE

This challenge makes accurate consumer demand forecasting and automated replenishment techniques more necessary than ever. A highly accurate forecast not only removes the guess work for the real potential of both products and stores/distribution centers, but delivers improved customer satisfaction, increased sales, improved inventory turns and significant return on investment.

According to certain embodiments described herein, demand forecast accuracy is improved by calculating a repeatability index or score and applying this score to the modeling process. The repeatability score reflects the reliability or quality of a seasonal forecast for a product. Products are sorted based on their reliability scores. Those products that are highly seasonal and have a reliable year-to-year demand pattern are used to form initial or unique demand models. Products that are determined to be less reliable based on their repeatability score are added to the unique demand models through an iterative matching process or left out of the unique demand models.

### BRIEF DESCRIPTION OF THE DRAWINGS

FIG. 1A shows a plot of seasonal sales data for a first item.

FIG. 1B shows a plot of seasonal sales data for a second item.

FIG. 2 illustrates a method for calculating a Quality Metric according to certain embodiments.

FIG. 3A shows product sales data from a relational database according to certain embodiments.

FIG. 3B shows seasonal demand and residual values used to calculate a Quality Metric according to certain embodiments.

FIG. 4 illustrates a method for generating seasonal demand models according to certain embodiments.

FIG. 5 illustrates a block diagram of a system for calculating a Quality Metric and generating seasonal demand models according to certain embodiments.

### DETAILED DESCRIPTION

This disclosure describes certain novel techniques for and further improvements to seasonal demand modeling or forecasting. Forecasts are used to predict the demand for certain products at given locations in order to increase or maximize sales while keeping storage and other costs low. Inaccurate forecasts can result in an overstock of slow moving products and out-of-stock situations for items during peak demand times. Good forecasts are the product of accurately modeling trend, seasonality, and causal effects. Of these three factors seasonality is the most influential in producing accurate forecasts. In fact, seasonal profiles are responsible for over 50% of the accuracy of a product's forecasted demand. This disclosure describes improved methods and systems for forecasting product demand based on seasonal demand patterns that can significantly improve the accuracy of demand forecasting.

Seasonal demand patterns correspond to the variation in demand depending on the time of year. This seasonal variation, also referred to as the product's seasonal profile, may vary greatly for different products. For example, the demand patterns for sun tan lotion and lawn and garden equipment look considerably different than the demand patterns for snow tires, school supplies or cold medication. Yet while many products will have very different seasonal profiles, some products will have closely related profiles. For example, it would be expected that ski gloves and ski hats have similar seasonal profiles.

Combined seasonal profiles are preferably calculated for these groups of products having similar seasonal selling patterns. This reduces noise, increases accuracy and improves forecasting efficiency. For example, goods in a particular level or class of store merchandise or a product hierarchy can be grouped together in order to generate a seasonal demand profile. However, such a grouping is not optimal in all situations, as products within a certain class can still have varying seasonal demand patterns.

An improved method for grouping products is described in U.S. patent application Ser. No. 10/724,840 by Kim et al., filed on Dec. 1, 2003, and entitled “METHODS AND SYSTEMS FOR FORECASTING SEASONAL DEMAND FOR PRODUCTS HAVING SIMILAR HISTORICAL SELLING PATTERNS”, the entire contents of which is incorporated herein by reference. It describes demand chain forecasting tools that provide retailers with a methodology for identifying products having similar seasonal selling profiles and sensibly aggregating seasonal profiles for these products to increase product demand forecast accuracy. Instead of using an arbitrary grouping, such as a merchandise hierarchy, the methods described use an automated clustering algorithm to group similarly shaped products using the historical selling patterns.

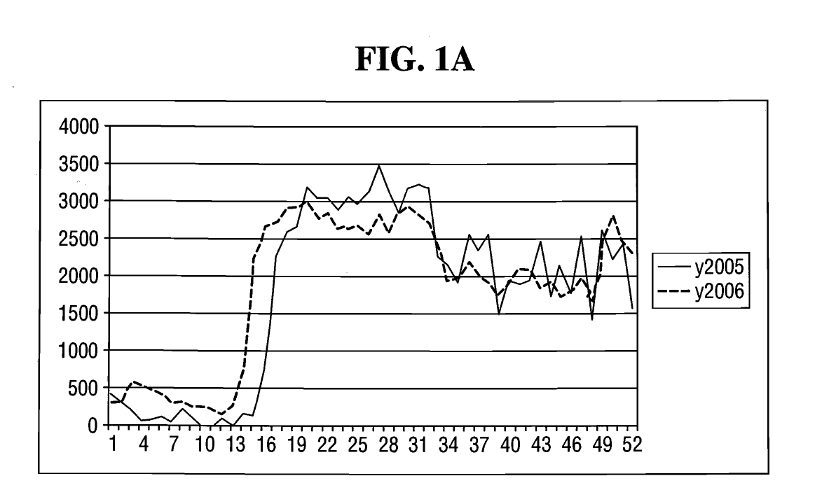

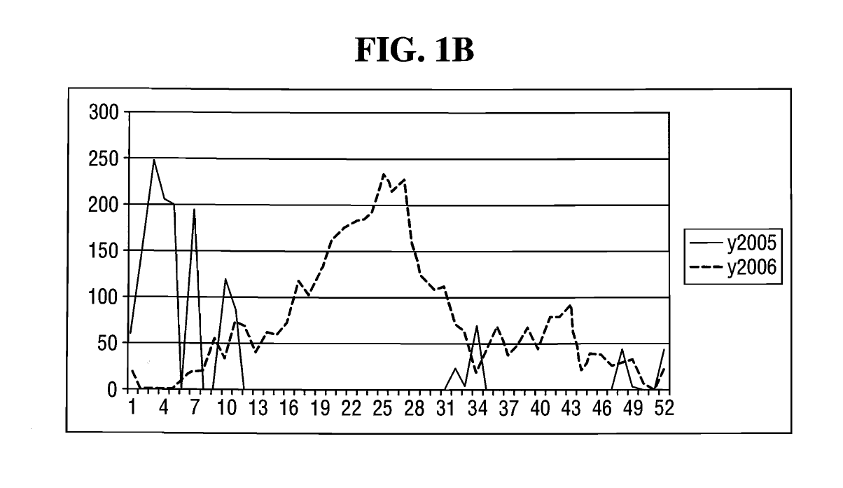

In that system, it was assumed for the purpose of developing seasonal demand forecasts that an item's sales data over multiple years gives a reliable annual seasonal selling pattern. In reality, the selling pattern of some items is more repeatable than others, as the example graphs show in FIGS. 1A and 1B. FIG. 1A shows the sales of a first item at a location over two years (2006, 2007). FIG. 1B shows the sales of a second item at the same location during the same two year time period. The graphs in FIGS. 1A and 1B show weekly sales of the corresponding products. The item in FIG. 1A clearly has a more repeatable (hence more reliable) selling pattern than the item in FIG. 1B, where the annual selling pattern does not match from one year to the next. When the seasonal pattern of a product is unpredictable (non-repeating year-to-year), grouping it with similar models is unlikely to yield useful forecasting results.

Rather than using all products in the grouping and modeling processes as in the previously described system, certain embodiments of this invention present a new metric: a repeatability score. The repeatability score embodies the distinction between a product having a reliable year-to-year seasonal pattern such as shown in FIG. 1A and a product that does not as shown in FIG. 1B. In one embodiment, the repeatability score is called a Quality metric (Qmetric), which assesses the repeatability, reliability, or quality of a given product's sales pattern. If it has a high repeatability score, then the product's sales pattern is particularly useful for generating forecast models because the existing data indicates that the product demonstrates a similar sales pattern year-to-year. As will be described below, these products are used in the “initial cluster seeding” process (called the Unique Model Process). If a product has a medium repeatability score, then it can be used in an iterative clustering process (called Automatic Profile Tuning or APT) in some embodiments. For products with a low repeatability score, the product is excluded from the clustering process and grouped into the general overall pattern (called the Master Model). Of course, the meaning of ‘high’ or ‘low’ scores are dependent on the particular reliability score used and may have different connotations in different embodiments. For example and as described below, a lower Quality metric value actually represents a higher repeatability or quality. Additionally, the scale of a repeatability score may vary based on the particular method used to determine the score.

It has been found that using a repeatability score in group demand forecasting, and particularly a Quality metric, significantly improves a seasonal forecast accuracy. Further, the number of clusters (groups of multiple products modeled together) were significantly reduced when compared to other methods of determining initial cluster seeding products. This has the added benefit of lower maintenance for the user. Thus, a more optimal solution is realized with the techniques described herein, since the higher forecast accuracy is achieved with lower number of clusters.

### Calculating a Quality Metric

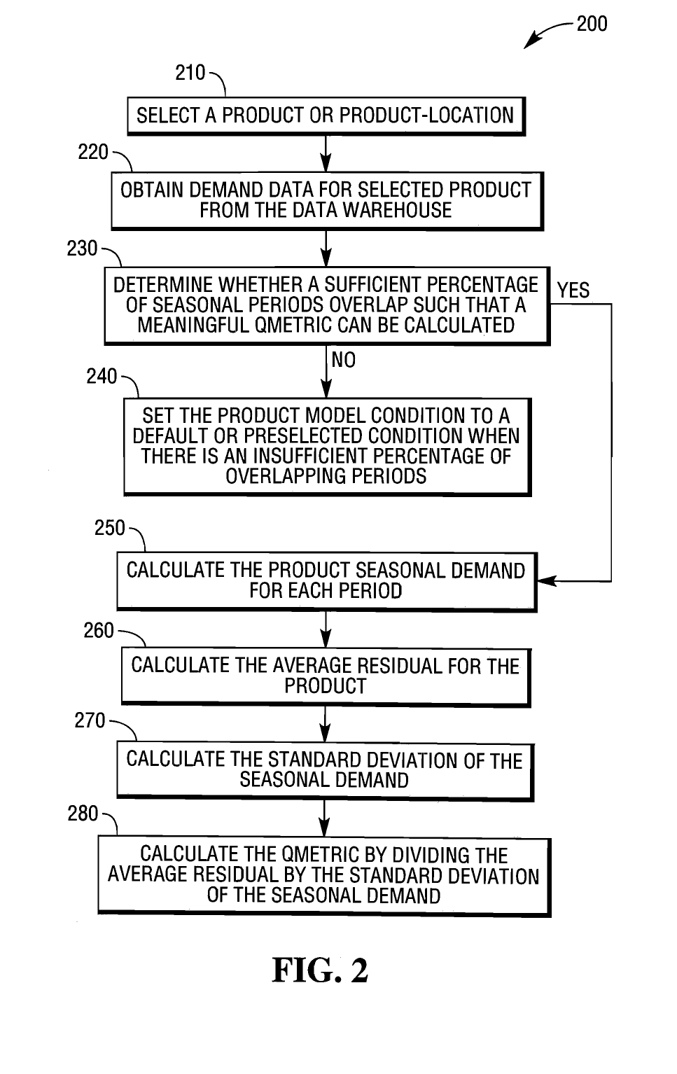

FIG. 2 shows a method 200 for calculating a Quality metric value according to one embodiment. The Quality metric value is one type of repeatability score for a seasonal demand pattern that indicates an extent to which demand for the product follows a seasonal pattern from year-to-year. That is, the Quality metric value is related to whether the product has a strong seasonal demand component. For example, a sunscreen product is likely to have a highly seasonal demand with high demand and sales in the summer and lower demand in the winter. In general, the Quality metric value described herein will be lower as the seasonality of the demand increases. However, other variations of the Quality metric value and other repeatability scores are possible.

At the state 210 of the method 200 for determining a Quality metric, a product is selected. A product is one or more goods or services provided or sold at one or more locations. For example, a product may comprise a particular brand and flavor of soda sold at a particular branch store of an international retailer. In another example, a product may comprise multiple flavors of soda sold at several vending machines located in a particular zip code or other geographic area. As used herein, a product can also refer to a product-location combination. For example, a first product is a brand and style of lights sold at a first retail location and a second product is the same lights sold at a second location.

The product selected is a product for which sales data or demand data exist in a data warehouse. The data warehouse is a relational database that stores sales data related to many (hundreds of thousands or more) products in table form. At the state 220, demand data related to the product is extracted from the data warehouse. The demand data comprises sales or order data taken over time and aggregated at periods or intervals. For example, the data may be stored in a relational database including several years of sales data collected at points of sale such as vending machines, store checkout counters, internet sales portals, or the like. The data is collected in real time in some embodiments. The data may be combined, aggregated, or averaged over each week, month, or other period. In some cases, data may be unavailable for certain periods.

Data is organized by seasons. Seasonal data corresponds to a particular group of time periods for which data is collected. Preferably, seasonal data corresponds to a 52 week season (year). In other embodiments, seasonal data corresponds to less than a year worth of data, such as 13 weeks. Data is typically stored for multiple seasons.

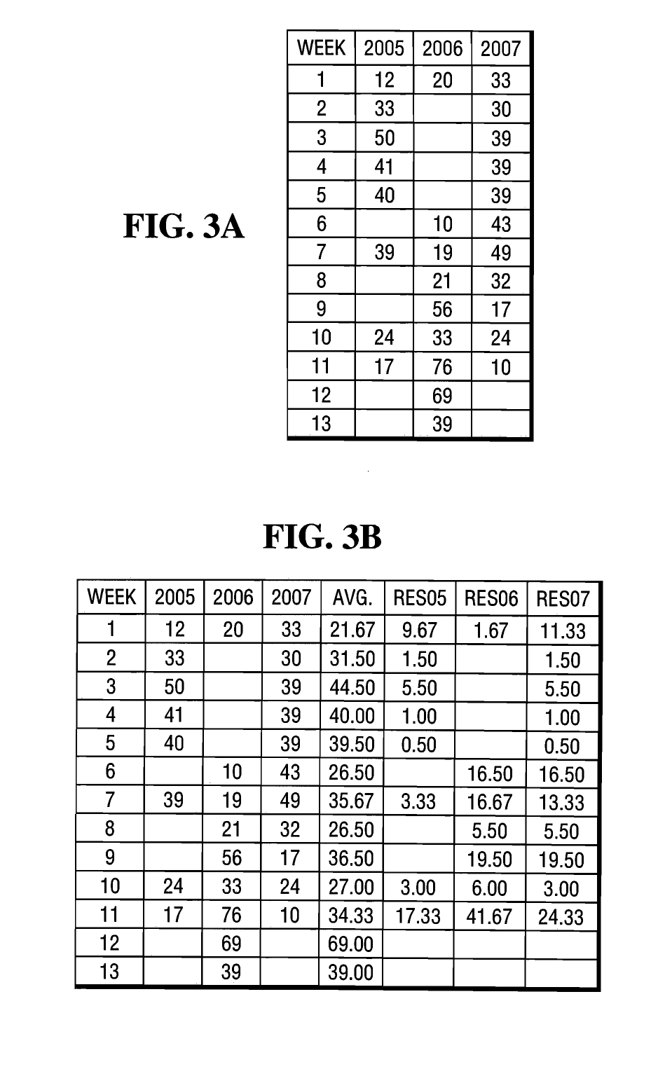

FIG. 3A shows an example of sale data for one product stored in a relational database according to some embodiments. In this example, the sales data is aggregated at weekly intervals or periods. For some of the weekly periods, no sales data is listed. This may be the case when data is unavailable for any reason, such as a product not being offered for sale for a given period. In some embodiments, any zero sales periods are not used. Data is available for three 13-week seasons corresponding to the years 2005, 2006, and 2007 in the example shown.

Additional data can be stored in the data warehouse and associated with each product. For example, a sale price, sale time, or any other information related to the sale of the product can be stored. However, only the sales or demand data is needed or extracted according to certain embodiments.

When the data has been obtained, the data set is analyzed at the state 230 to determine whether sufficient overlapping data points exist for the seasonal data in order to qualify for a Quality metric rating. That is, it is determined whether a sufficient number of overlapping periods have non-zero demand data in multiple seasons. An overlapping period is a week or other period that occurs at the same time in multiple seasons, such as the first week, second week, first month, or the like. For example, the seasonal data set in FIG. 3A comprises thirteen weeks in each of three years. The seasonal data has non-zero values for eight of the weeks in the first season (2005), nine weeks in the second season (2006), and eleven weeks in the third season (2007). Eleven of the weeks have at least two data values over the three seasons. The data set in FIG. 3A is therefore said to have approximately 84.6% (=11/13) overlapping weeks or periods. In one embodiment, only when overlapping weeks have non-zero data values for all of the seasons is the period considered to have overlapping data. In the same example from FIG. 3A, there are only four weeks having data values for each of the three seasons, corresponding to approximately 30.8% (=4/13) overlapping weeks.

Testing has shown that forecast error decreases for a product demand forecast as the percentage of overlapping periods increases in the existing sales data. Accordingly, the percentage of overlapping weeks or periods is used to determine whether a sufficient amount of seasonal data is available to generate a meaningful model at the state 230.

In order to test this at the state 230, a parameter is selected and compared to the percentage of overlapping periods. For example, the parameter may be 80%, in which case for the thirteen week season described above, a Quality metric would only be calculated when there were at least eleven overlapping weeks. In other embodiments, the percentage of overlapping weeks required may be any percentage, but preferably between approximately 50% and 80%. The best value is determined by experimental analysis of the data available from the data warehouse in some embodiments.

If there is not sufficient overlap for the product, then the method 200 may proceed to the state 240 where a product model condition is selected for the product. The condition is a default condition that defines how the product is to be used in the modeling process in some embodiments. For example, the condition can be one of: using the product in the master model only; allowing the product to be used to seed unique models in the iterative process; allowing the product to be grouped with unique models but not used to develop the models; or allowing the product to be used in generating a unique model. In some embodiments, a default condition is determined for some or all of the products, and different products can have different default conditons.

If there is sufficient overlap at the state 230, then the process 200 continues to the state 250 and seasonal demand is calculated based on the product data. The seasonal demand corresponds to the average sales or demand for each period in the season. FIG. 3B shows the seasonal demand for the product data under the column “Avg.” in the same example used in FIG. 3A. Thus, 13 seasonal demand values are calculated in this example, the first week seasonal demand value being approximately 21.67. In other embodiments, different periods and seasons are used as discussed above.

At the state 260, the average residual is calculated. Residuals correspond to the absolute difference between the seasonal demand (average demand for each period found above), and the actual demand for a particular period and season. All of the residuals across each of the periods and seasons are averaged in order to determine the average residual. Using the example of FIG. 3B again, the residuals for each week-year combination are shown, with the week 1 residuals being 9.67, 1.67, and 11.33 for 2005, 2006, and 2007, respectively These are averaged with the remaining residuals for each week-year combination. In this example, zero sale or no sale data is not used. The average residual for the data in FIG. 3B is approximately 9.67. In general, a larger average residual will correspond to a more reliable or a repeating demand pattern, such as for the product shown in FIG. 1A. A low average residual will correspond to an unreliable demand pattern, such as for the product shown in FIG. 1B.

At the state 270, the standard deviation of the seasonal demand is calculated. In the example of FIG. 3B, the standard deviation is 11.86. In general, a high standard deviation corresponds to a unique or seasonal sales pattern. A low standard deviation generally corresponds to a stable sales pattern.

At the state 280, the Quality metric is calculated by dividing the average residual by the standard deviation. Because the average residual decreases as the reliability in the seasonal pattern increases, while at the same time the standard deviation increases as the period demand fluctuates more corresponding to a seasonal pattern, lower Quality metric values will represent reliable seasonal patterns. In the example of FIGS. 3A-B, the Quality metric is approximately 0.82.

A new product can be selected if necessary or desired to calculate another Quality metric value. In some embodiments, a Quality metric is calculated for every product or product-location represented in the data warehouse. In some embodiments the Quality metric values are stored in the data warehouse after being determined. In other embodiments, selected products are modeled and the Quality metric is determined during the modeling process.

According to other embodiments, certain actions described above with respect to the method 200 may be modified, omitted, or performed in a different order than that listed above. Additional actions may be added in some embodiments. For example, the product demand data is filtered in some embodiments to remove outlier data. An outlier can be any data point outside of two standard deviations from the average for a weekly demand, or can be determined in some other way.

### Using Quality Metrics to Generate Demand Forecasts

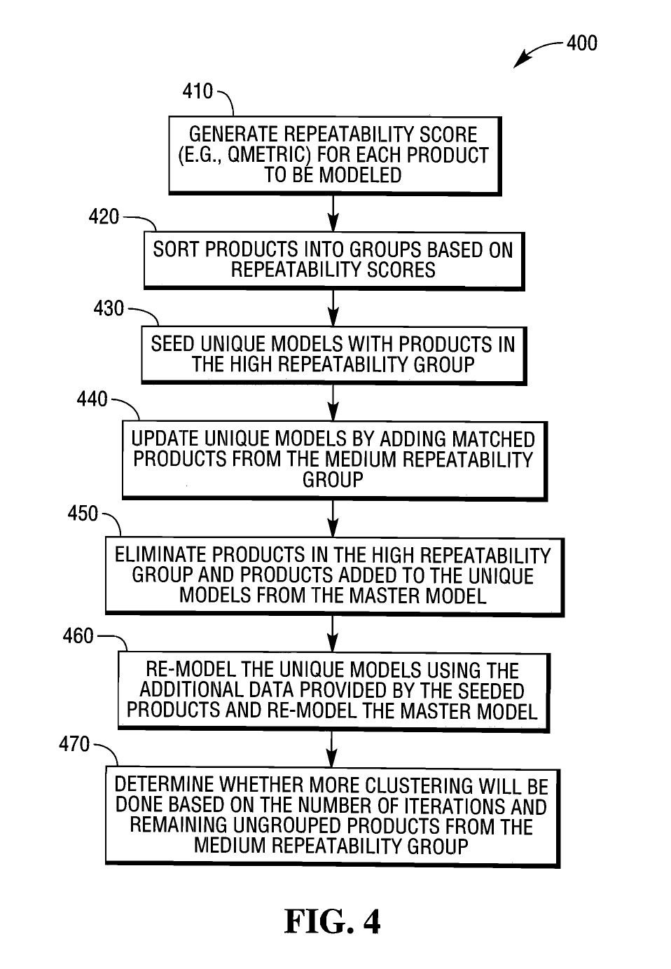

FIG. 4 shows a method for developing future demand models or forecasts using a Quality metric according to one embodiment. The Quality metric values are used to sort the products, determining which products are used to seed unique models. This delivers improved accuracy, as those products with reliable seasonal patterns become the foundation of the demand forecasts.

At the state 410, Quality metric values are calculated for products in the data warehouse based on the sales data. For example, Quality metric values are calculated as described above with reference to method 200 and FIG. 2. In other embodiments, some other repeatability score is calculated.

When Quality metric values have been determined for products in the database, those Quality metric values are used to sort the products into one or more categories at the state 420. In one example, the values are sorted into three groups according to two selected parameters. Those products having a Quality metric value less than or equal to a first parameter (Q≦P₁), representing those products having highly seasonal demand patterns, are selected for a high repeatability first group. Those products having Quality metric values more than the first parameter and less than or equal to a second parameter (P₁<Q≦P₂) are selected for a medium repeatability second group. The remaining products having Quality metric values greater than both the first and second parameter (P_{1<}P₂<Q) are selected for a low repeatability third group. For example, the first parameter is between approximately 0.5-1.0, and the second parameter is greater than the first parameter and between approximately 0.8-1.5.

While the process described here uses three categories or groups, it is also possible to use a greater or smaller number of groups in some embodiments. For example, only two groups can be used. A first group can comprise high repeatability products used to seed unique models. The second group may comprise the remaining products. Those products can be used in the iterative clustering process as described below, or can be maintained entirely in the Master Model. In other embodiments, four groups are used. The extra group can, for example, contain those products having a Quality metric greater than the first and second parameters, but less than or equal to a third parameter (P₁<P₂<Q≦P₃). Those products in the newly created group can be added to substantially matching clusters after the iterative process of clustering is complete in some embodiments so that they do not affect the models.

Returning to the example of three groups at the state 430, those products having a Quality metric value associated with a highly seasonal demand pattern are used to generate unique demand models. That is, a predictive demand model is generated based on stored demand data for each of the products in the first group. As an example, refer again to the product data represented in FIGS. 3A and 3B. Assuming a first parameter, P₁, defining the first group of repeatable products as those with a Quality metric of less than 1.0, then this product would be in the first group. A seasonal demand forecast would therefore be generated at state 330 based on this data.

At the state 440, products in the second group are added to the existing unique models generated at the state 330 to form clusters. Historical sales data for these products are compared to the unique models, and when there is a sufficient fit (as described in more detail in U.S. patent application Ser. No. 10/724,840, referenced above), then these products are grouped or clustered with a product (or cluster in later iterations) having a similar seasonal demand pattern.

At the state 450, those products used to create unique models or added to the unique models are eliminated from the Master Model in some embodiments. The Master Model therefore contains all of the low repeatability group products, along with those of the medium repeatability products that did not fit any of the unique models or clusters.

At the state 460, the unique models and clusters are re-modeled using the additional data provided by the added products. That is, data for the products in the second group that have been added to a unique model are combined with the data for the existing model. The data may be normalized in some embodiments. The combined data is used to generate a new seasonal demand model or forecast. The Master Model is also re-modeled in some embodiments.

At the decision state 470, the process may proceed to an end whereby the generated models can be provided to a user such as through a visual display, on a printout, to an automated inventory system, or the like. The process 400 may repeat the states 440, 450, and 460 in an iterative process in some embodiments in order to further group medium repeatability products into clusters. The iterative process can continue for a preselected number of iterations or until all of the products in the second group have been seeded to a unique model. During the iterative process, the cluster sizes are generally increased while the Master Model size is decreased. In some embodiments, products having unique models or entire clusters can be joined with another cluster when the seasonal patterns are similar.

### System

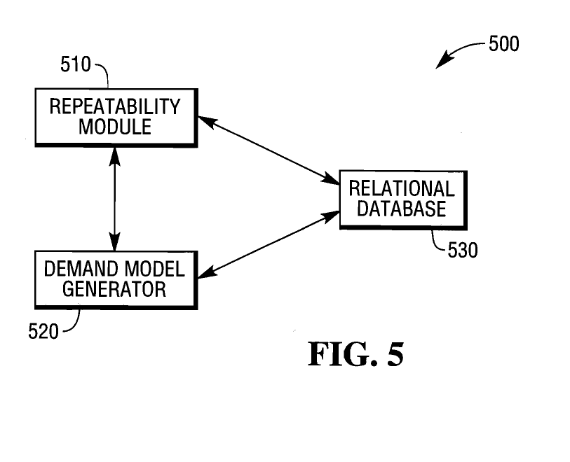

FIG. 5 is a diagram of a demand forecast modeling system 500, according to an example embodiment. The demand forecast modeling system 500 is implemented as instructions within one or more machine accessible or computer-readable medium. The demand forecast modeling system 500 implements, among other things, the methods 200 and 400 of the FIGS, 2 and 4.

The demand forecast modeling system 500 includes repeatability module 510, a demand model generator 520, and a relational database 530. The repeatability module 510 is integrated with the demand model generator in certain embodiments.

The repeatability module 510 extracts data from the relational database 530 for use in developing a repeatability score or Quality metric value for product data in the relational database 530. The repeatability module 510 stores the Quality metric value in the relational database 530 in certain embodiments. In some embodiments, the Quality metric value or repeatability and score is provided to the demand model generator 520.

The demand model generator 520 accesses the relational database 530 and produces a demand model for products corresponding to the demand data stored in relational database 530. The Quality metric value or repeatability score is used to determine products that are used for generating unique demand models, the products that added to the unique demand models to form clusters, and the products that remain in the Master Model according to certain embodiments. The details of this as well as illustrative examples are provided above with reference to FIGS. 1-4.

Certain embodiments of the inventions described in this disclosure provide advantages over the prior art. For example, some embodiments provide improved forecast accuracy. Extensive testing with various data sets (including high/low volume categories, and highly seasonal vs. all year round products) showed statistically significant improvement in forecast accuracy, such as by reducing error by approximately 2% or more depending on the products modeled. In some embodiments, fewer profile cluster groups are generated as compared with previous systems. This significantly lower number of clusters or groups, often up to 90% lower, aids in the users' maintenance of the demand profiles. A user can review only a few seasonal profiles rather than hundreds of seasonal profiles with the previous systems. It will be understood that other advantages can be realized utilizing the novel features described in this disclosure, and that not every advantage or feature described herein will be present in every embodiment.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

What is claimed is:

1. A machine implemented method comprising:
determining a plurality of repeatability scores based on sales data, each of the repeatability scores associated with one of a plurality of products;
selecting at least one of the products based at least in part on the repeatability score associated with the selected product; and
generating a model of future demand for the selected at least one product.

2. The method of claim 1, wherein the repeatability scores comprise a plurality of quality metrics.

3. The method of claim 2, wherein determining each of the quality metrics comprises:
calculating a seasonal demand for each of a plurality of periods based on the sales data;
calculating a standard deviation for the seasonal demand based on the seasonal demand for each of the plurality of periods;
determining an average residual based on the seasonal demand for each of the plurality of products and the sales data; and
dividing the average residual by the standard deviation of the seasonal demand.

4. The method of claim 3, wherein determining each of the quality metrics further comprises:
obtaining the sales data from a database, the sales data comprising a plurality weekly sales figures over at least two years;
determining an overlap percentage based on the presence of the weekly sales figures for each of a plurality of weeks in at least two of the at least two years; and
comparing the overlap percentage to a preselected overlap threshold.

5. The method of claim 4, wherein determining each of the quality metrics further comprises setting a default condition for the associated product when the overlap percentage is less than the preselected overlap threshold, the default condition comprising one of: assigning the associated product to a master model; assigning the associated product to a unique model; or assigning the associated product to be used in a clustering process.

6. The method of claim 1, wherein selecting at least one of the products comprises:
comparing the plurality of repeatability scores to a preselected value;
sorting the products into two or more categories based on whether the repeatability score associated with each of the products is greater or less than the preselected value; and
selecting at least one of the products from a first group corresponding to one of the two or more categories.

7. The method of claim 1, wherein selecting at least one of the products comprises:
comparing the plurality of repeatability scores to a first preselected value;
comparing the plurality of repeatability scores to a second preselected value;
sorting the associated products into three categories based on the comparisons to the first and second preselected values; and
selecting at least one of the products from a first group corresponding to one of the three categories.

8. The method of claim 7, further comprising:
selecting an additional product from a second group corresponding to one of the three categories;
matching the additional product from the second group with one of the at least one selected products from the first group; and
generating a second model of future demand for a cluster, the cluster comprising the matched product from the first group and the additional product from the second group.

9. The method of claim 7, further comprising:
selecting a plurality of additional products from a second group corresponding to one of the three categories;
matching the plurality of additional products from the second group with one of the at least one selected products from the first group; and
generating a second model of future demand for a cluster, the cluster comprising the matched product from the first group and the plurality of additional products from the second group.

10. The method of claim 7, further comprising generating a master model, the master model comprising a second model of future demand for a plurality of additional products form the third group corresponding to one of the three categories, wherein the third group corresponds to a subset of the plurality of products that have non-seasonal demand patterns based on the repeatability scores associated with the subset of the plurality of products.

11. The method of claim 7, wherein the first preselected parameter is between approximately 0.5 and 1.0.

12. The method of claim 7, wherein the second preselected parameter is between approximately 0.7 and 1.5.

13. A machine implemented method for generating a quality metric comprising:
calculating a seasonal demand for a product using stored demand data;
calculating a residual for the product based on the seasonal demand and the stored demand data; and
generating a quality metric by comparing the residual to a variation of the seasonal demand.

14. The machine implemented method of claim 13, wherein calculating the seasonal demand for the product comprises determining a plurality of average weekly sales volumes based on the stored demand data.

15. The machine implemented method of claim 14, wherein calculating the residual comprises comparing the plurality of average weekly sales volumes to a plurality of corresponding weekly sales values.

16. The machine implemented method of claim 13, wherein generating a quality metric comprises dividing the residual by a standard deviation of the seasonal demand.

17. The machine implemented method of claim 13, further comprising:
determining whether the quality metric is within a preselected range corresponding to a repeatable product; and
generating a demand forecast for the product when it is determined that the quality metric is within the preselected range.

18. A system comprising:
a database comprising a plurality of entries; each of the entries corresponding to a product-location and comprising sales data;
a repeatability score module configured to access the database and determine a repeatability score for each of the plurality of entries; and
a demand model generator configured to access the database and receive the repeatability score for each of the plurality of entries, the demand model generator further configured to generate seasonal demand forecasts for a subset of the plurality of entries using the corresponding sales data, the demand model generator further configured to select the subset based at least in part on the repeatability score for each of the plurality of entries.

19. The system of claim 18, wherein the repeatability score comprises a quality metric.

20. The system of claim 18, wherein the demand model generator is configured to select the subset by comparing the repeatability score for each of the plurality of entries to a preselected parameter.
